(19) United States
(12) Patent Application Publication
(10) Pub. No.: US 2003/0148148 A1
(43) Pub. Date: Aug. 7, 2003

(54) Combined heat insulating layer systems

(76) Inventors: Markus Dietrich, Julich (DE); Robert Vassen, Herzogenrath (DE); Cao Xueqiang, Julich (DE); Detlev Stover, Niederzier (DE)

Correspondence Address: SCHWEITZER CORNMAN GROSS & BONDELL LLP, 292 MADISON AVENUE - 19th FLOOR, NEW YORK, NY, 10017, US

(21) Appl. No.: 10/204,588

(22) PCT Filed: Feb. 6, 2001
(86) PCT No.: PCT/EP01/01235

(30) Foreign Application Priority Data
Feb. 25, 2000 (DE) 100 08 861.9

(51) Int. Cl. B32B 18/00

(52) U.S. Cl. 428/701; 428/702; 428/472

(57) ABSTRACT

The invention discloses a component with a heat-insulating layer on its surface. The heat-insulating layer comprises a lower region and an upper region. The lower region is situated between the component and the upper region. The lower region consists entirely or predominantly of YSZ or a glass-metal composite material.

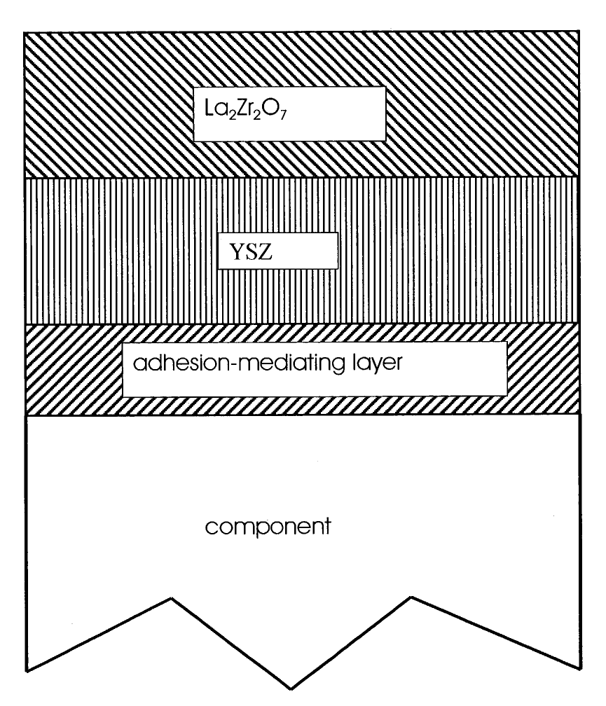

The upper region consists entirely or predominantly of a material which provides a stable phase at temperatures significantly above 1200° C.

The component can be used at temperatures significantly above 1200° C.

The invention discloses a component with a heat-insulating layer, suitable for use at high temperatures. The components of a gas turbine represent one known example of a component of this kind.

Efforts are currently being made to raise gas temperatures in the associated engines in order to increase the efficiency of stationary and airborne gas turbines. For this purpose, components of the turbines are provided with heat-insulating layers, which generally consist of YSZ, that is, zirconium oxide partially stabilised with Y₂O₃. An adhesion-mediating layer made from a MCrAlY alloy (M═Fe, Co, Ni) between the substrate and the heat-insulating layer primarily protects the substrate from oxidation and improves the adhesion of the YSZ-ceramic layer which is applied by thermal spraying onto the substrate. Alternatively, an aluminide layer can be used as an adhesion-mediating layer. This can be produced by aluminium diffusion into the surface of the substrate.

Using heat-insulating layer systems, it is now possible to realise surface temperatures for turbine components up to 1200° C. over long operating periods. A further increase to temperatures above 1300° C. is desirable, but cannot be realised with the currently available heat-insulating layer systems. Accordingly, new solutions are being sought worldwide to replace the partially stabilised zirconium oxide.

The object of the present invention is to produce a heat-insulating layer which is suitable for use at temperatures above 1200° C.

The object of the invention is achieved with a heat-insulating layer which provides the features of the first claim. Advantageous embodiments are described in the dependent claims.

The component claimed provides a heat-insulating layer on its surface. The heat-insulating layer comprises a lower and an upper region. The lower region is situated between the actual component and the upper region. The lower region consists entirely or predominantly of stabilised ZrO₂ or a glass-metal composite material. The upper region consists entirely or predominantly of a material which provides a stable phase at temperatures from 0° C. to at least 1200° C. A stable phase is present in the sense of the invention if no phase change coupled with an abrupt change in the coefficient of thermal expansion, takes place within the temperature interval indicated.

In one improved embodiment of the invention, the heat-insulating layer is situated on an adhesion-mediating layer.

The lower region is formed, for example, by a layer, referred to below as the contact layer. It consists of YSZ or glass-ceramic composite materials.

It has been shown that roughness on the surface to which the heat-insulating layer is applied causes mechanical stresses in the heat-insulating layer. These mechanical stresses are routinely and to a considerable extent responsible for defects occurring in the heat-insulating layer. In selecting the material for the contact layer, it is therefore preferable to ensure a large coefficient of thermal expansion, because this minimises the mechanical stresses. At least in the lower region, the coefficient of thermal expansion of the heat-insulating layer should be at least 10*10⁻⁶ K⁻¹, in order to ensure the occurrence of low mechanical stresses.

In particular, the contact layer is at least 50 μm thick, preferably 100 μm thick, in order to achieve the desired effect mentioned above.

To ensure that the contact layer is not exposed to excessively high temperatures, the upper region with the low thermal conductivity is situated above the lower region. The thickness of this region should be selected so that the lower region is adequately temperature-protected.

The upper region can also be provided in the form of a layer, referred to below as the covering layer.

In principle, any materials which primarily fulfil the criteria of phase stability and low thermal conductivity might be considered as the material for the covering layer and/or the upper region. Relevant examples are fully-stabilised cubic zirconium oxide, oxides with a perovskite structure or pyrochlore structure, such as La₂Zr₂O₇ or Nd₂Hf₂O₇ or also doped variants of these materials. The materials named by way of example provide the desired low thermal conductivity as well as the desired stable phase at the target operating temperature above 1200° C.

The layers can be applied by various processes, such as LPPS (Low pressure plasma spraying), APS (Air plasma spraying) and EB-PVD (Electron beam physical vapour deposition). However, other processes are also equally possible.

In selecting the materials, it is also particularly important to ensure their capability for thermocycling in the sense of their ability to resist extreme cyclical temperature-change stresses. Premature failure in thermocycling frequently occurs in layer systems because of the differences in the coefficient of thermal expansion of the different materials. During the heating and cooling of the layers, thermal stresses occur, which can cause damage and lead to the failure of the structure. With the substrate materials and the adhesion-mediating layer used, the coefficient of thermal expansion reaches a value of approximately 14*10⁻⁶ K⁻¹, which is high for ceramic systems. The currently used heat-insulating layer material, YSZ, provides a coefficient of thermal expansion of 10.4*10⁻⁶ k⁻¹. In this context, the substrate material is defined as the material onto which the heat-insulating layer, optionally including the adhesion-mediating layer, is applied.

Given the same thermal conductivity of the heat-insulating layer and the same layer thickness, increased surface temperatures also lead to higher temperatures at the interface with the adhesion-mediating layer and the substrate material. In existing heat-insulating layer systems, this temperature increase also damages the bonding. With the heat-insulating layer system according to the invention, a low thermal conductivity has been selected both in the lower region and also in the upper region. The higher the thermal conductivity of the upper region is, the thicker this region must be. Since even the material of the lower region (contact layer) can only provide limited thermal stability, good heat insulation must be achieved especially by the upper region (covering layer).

At temperatures above 1200° C., the YSZ used according to the prior art is subject to a phase change which causes damage to the layer. This problem has been resolved according to the invention by providing the upper region. It is therefore important to ensure the phase stability of the material up to the desired temperatures, and if possible, even up to the melting point.

Hitherto, no material has been found which combines all the desired properties to an adequate extent. However, some materials do fulfil one or two of the requirements. The invention is therefore based on the idea, of combining the various ceramic materials in a layer system. In this context, the material in contact with the adhesion-mediating layer provides a coefficient of thermal expansion and a tolerance to damage which guarantees the material's capability for thermocycling, while the material on the surface of the layer provides the properties, such as e.g. phase stability, necessary in order to withstand temperatures above 1200° C.

The idea of the invention is implemented as follows:

1) Multiple Layer System (Multilayer)

A heat-insulating layer consists of a contact layer and a covering layer. The contact layer is situated between the adhesion-mediating layer and the covering layer.

2) Graduated Layer

A heat-insulating layer provides a concentration gradient. The proportion of two materials changes continuously within the heat-insulating layer.

Combinations of 1) and 2) are possible.

### EXEMPLARY EMBODIMENTS

1. Heat-Insulating Layer Made from YSZ and La₂Zr₂O₇.

YSZ-powder and MCrAlY-powder (adhesion-mediating layer) suitable for plasma spraying are available industrially. The La₂Zr₂O₇ powder is manufactured by spray-drying an aqueous La(NO₃)₃-solution and Zr(NO₃)₂-solution with subsequent calcination at 1400° C. Finally, the adhesion-mediating layer is applied by means of LPPS to the substrate material, which consists of a nickel-based alloy. A layer of YSZ 0.05-0.2 mm thick is first applied by means of EB-PVD to the adhesion-mediating layer as a contact layer. A pyrochlore layer is then applied by means of EB-PVD as a covering layer with a thickness of at least 0.1 mm.

2. Graduated Heat-Insulating Layer Made from Glass-Metal Composite and Cubic Zirconium Oxide

Cubic zirconium oxide powder and an adhesion-mediating-layer powder are industrially available. The powder for the glass-metal composite is manufactured by mixing and grinding super-fine glass powder with adhesion-mediating-layer powder.

The adhesion-mediating layer is first applied by means of LPPS.

During the plasma-spraying of the graduated heat-insulating layer, the glass-metal powder and the ZrO₂-powder are supplied to the plasma canon from different pumping units; initially, predominantly glass-metal-powder is supplied. During the course of the spraying procedure, the proportion of glass-metal powder is reduced continuously, while the pumped quantity of cubic zircon oxide is increased by the same proportion.

In this manner, the graduated heat-insulating layer is manufactured with a total thickness of approximately 0.3 mm.

3. Combination of Multilayer and Graduated Layer Consisting of YSZ and Tantalum-Doped YSZ (Ta-YSZ)

YSZ-powder and MCrAlY-powder (adhesion-mediating-layer powder) suitable for plasma spraying are industrially available.

Ta-YSZ is manufactured via a solid reaction according to the following equation

Ta₂O₅+YSZ→YSZ*Ta₂O₅.

The starting powders are ground in a ball mill under ethanol and then calcined at 1400° C. After the reaction which takes place at 1400° C., a pourable powder is produced by spray drying.

After the adhesion-mediating layer has been applied to the substrate, a YSZ-layer is sprayed to a thickness of approximately 0.05 to 0.1 mm. A graduated layer as described in 2) consisting of YSZ and Ta-YSZ is then applied to a thickness of at least 0.1 mm. Finally, a covering layer made from pure Ta-YSZ is applied to a thickness of 0.05-0.1 mm. All three layers are applied by means of APS.

1. Component with a heat-insulating layer on its surface,
characterised in that
the heat-insulating layer provides a lower and an upper region,
the lower region is situated between the component and the upper region
the lower region consists entirely or predominantly of YSZ or a glass-metal composite material,
the upper region consists entirely or predominantly of a material which provides a stable phase at temperatures from 0° C. to at least 1200° C.

2. Component according to claim 1, wherein the coefficient of thermal expansion in the lower region is greater than the coefficient of thermal expansion in the upper region.

3. Component according to claim 1 or 2, wherein the heat-insulating layer is situated on an adhesion-mediating layer.

4. Component according to any one of the preceding claims, wherein the lower region is formed by a layer consisting of YSZ or glass-metal composite materials.

5. Component according to any one of the preceding claims, wherein the lower region is formed by a layer at least 50 μm, preferably at least 100 μm thick.

6. Component according to any one of the preceding claims, wherein the upper region is formed by a layer.

7. Component according to any one of the preceding claims, wherein the upper layer is made at least predominantly of fully stabilised, cubic zirconium oxide, oxides with perovskite structure or pyrochlore structure such as e.g. La₂Zr₂O₇ or Nd₂Hf₂O₇ or doped variants of these materials.

8. Component according to any one of the preceding claims, wherein the heat-insulating layer is formed by a graduated layer.

9. Component according to any one of the preceding claims, wherein the upper region is at least 0.1 mm thick.

10. Component according to any one of the preceding claims, wherein the upper region consists entirely or predominantly of a material, which provides a stable phase at temperatures up to at least 1300° C.

11. Component according to any one of the preceding claims, wherein the thermal insulation provided by the upper region is greater than the thermal insulation provided by the lower region.

12. Use of a component according to any one of the preceding claims at temperatures above 1200° C.
